(19) United States
(12) Patent Application Publication
(10) Pub. No.: US 2006/0024213 A1
(43) Pub. Date: Feb. 2, 2006

(54) Substrate treating apparatus

(75) Inventor: Kenichiro Arai, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/177,624

(22) Filed: Jul. 8, 2005

(30) Foreign Application Priority Data
Jul. 28, 2004 (JP) 2004-220245

(51) Int. Cl. B01J 19/00

(52) U.S. Cl. 422/129; 422/236

(57) ABSTRACT

A substrate treating apparatus for performing a predetermined treatment of substrates, includes a treating tank for storing a treating solution, a holding mechanism for holding the substrates, and loading and unloading the substrates into/from the treating tank, a first lid member for opening and closing an upper opening of the treating tank, the first lid member having an insert opening for receiving a back plate of the holding mechanism, and a second lid member disposed on the first lid member for opening and closing the insert opening. When the holding mechanism is outside the treating tank and the first lid member is closed, the second lid member closes an area above the insert opening, and forms lateral openings.

### BACKGROUND OF THE INVENTION

(1) Field of the Invention

This invention relates to a substrate treating apparatus for treating substrates such as semiconductor wafers, glass substrates for liquid crystal displays and the like (hereinafter called simply “substrates”) by supplying a treating solution thereto.

(2) Description of the Related Art

Known substrate treating apparatus of this type include, for example, an apparatus for treating substrates by immersing the substrates in a treating solution stored in a treating tank. Specifically, the apparatus includes a lifter vertically movable for carrying the substrates into and out of the treating tank, and an auto cover for opening and closing an upper opening of the treating tank. The auto cover has an insert opening that is opened when the lifter moves vertically, and closed when the lifter lies in the treating tank. When closed, the auto cover is kept out of interference with the back plate of the lifter (Japanese Unexamined Patent Publication No. 7-176506 (1995), for example).

The apparatus having the above construction carries out a temperature control of the treating solution in the treating tank while keeping the lifter outside the treating tank with the auto cover closed. The auto cover is provided in order to prevent particles from mixing into the treating solution, and to prevent the treating solution from deteriorating through contact with ambient air. When the treating solution reaches a treatment temperature, the auto cover is opened, and the lifter with substrates placed thereon is lowered into the treating tank. Subsequently, the auto cover is closed, and treatment is carried out for a predetermined time. The back plate of the lifter is located in the insert opening formed in the auto cover, and does not interfere with the auto cover.

The conventional apparatus described above has the following drawback.

In order to increase processing speed, it is common practice that the conventional apparatus heats the treating solution to a high temperature. Thus, even when the auto cover is closed, the treating solution scatters through the insert opening. This contaminates surroundings of the treating tank to require frequent maintenance, and such maintenance operation takes a long time.

In order to solve the above problem, it is conceivable to provide a cover for closing the insert opening to seal off the interior of the treating tank when the lifter is located outside the treating tank. However, the provision of such a cover gives rise to the following problems.

A phosphoric acid solution may be used for etching nitride film, for example. The phosphoric acid solution is heated to a high temperature of about 160° C. in order to realize a predetermined etching rate. Specifically, substrates are treated in the phosphoric acid solution sustained in a gently boiling state (hereinafter called the sub-boil state) after reaching a boiling state. In a transition to the sub-boil state, the phosphoric acid solution (usually 86 wt %) supplied to the treating tank boils intensely at about 140 to 150° C., thereby evaporating water from the phosphoric acid solution. Subsequently, the phosphoric acid solution boils down slowly to stabilize in the sub-boil state at 160° C.

However, where the above-noted cover is provided for preventing scattering of droplets, the evaporation of water is hampered so that the moisture concentration can hardly be lowered. This poses a different problem of the intense boiling state continuing for a long time, thereby causing a long delay in attaining a steady sub-boil state.

### SUMMARY OF THE INVENTION

This invention has been made having regard to the state of the art noted above, and its object is to provide a substrate treating apparatus having a sub cover devised to allow for a proper water evaporation, while preventing scattering of a treating solution in a boiling state, thereby to stabilize the treating solution in a sub-boil state quickly.

The above object is fulfilled, according to this invention, by a substrate treating apparatus for performing a predetermined treatment of substrates, comprising a treating tank for storing a treating solution; a holding mechanism for holding the substrates, and loading and unloading the substrates into/from the treating tank; a first lid member for opening and closing an upper opening of the treating tank, the first lid member having an insert opening for receiving a back plate of the holding mechanism; and a second lid member disposed on the first lid member for opening and closing the insert opening; wherein, when the holding mechanism is outside the treating tank and the first lid member is closed, the second lid member closes an area above the insert opening, and forms lateral openings.

When the holding mechanism is outside the treating tank and the first lid member is closed, the second lid member closes an area above the insert opening, and forms lateral openings. The second lid member closing the area above the insert opening can prevent upward scattering of the treating solution. In addition, since the second lid member forms lateral openings, the evaporation of water from the treating solution is not hampered. Consequently, the above construction is effective to prevent scattering of the treating solution in a boiling state, and to stabilize the treating solution in a sub-boil state quickly.

The second lid member may be pivotably attached to open and close axes disposed on an upper surface of the first lid member.

When the first lid member is opened or closed, the second lid member may also be opened or closed on the first lid member. Thus, the second lid member does not require a drive mechanism of its own, which contributes to simplification of the apparatus.

The second lid member may include a pair of lid plates, the pair of lid plates presenting a cross-sectional shape resembling letter M when closing the area above the insert opening.

The cross-sectional shape resembling letter M of the lid plates gives a certain mechanical strength to the lid plates, and at the same time secures sufficient laterally opening areas.

In another aspect of the invention, a substrate treating apparatus for performing a predetermined treatment of substrates, comprises a treating tank for storing a treating solution; a holding mechanism for holding the substrates, and loading and unloading the substrates into/from the treating tank; a first lid member for opening and closing an upper opening of the treating tank, the first lid member having an insert opening for receiving a back plate of the holding mechanism; and a second lid member disposed on the first lid member for opening and closing the insert opening; wherein, when the holding mechanism is inside the treating tank and the first lid member is closed, a distal end of the second lid member is in contact with the back plate.

When the holding mechanism is inside the treating tank and the first lid member is closed, a distal end of the second lid member is in contact with the back plate. At this time, the second lid member closes an area above the insert opening to prevent upward scattering of the treating solution. In addition, since the second lid member forms lateral openings, the evaporation of water from the treating solution is not hampered. Consequently, the above construction is effective to prevent scattering of the treating solution in a boiling state, and to stabilize the treating solution in a sub-boil state quickly. Further, the second lid member stabilizes with the distal end thereof contacting the back plate. There is no need to provide an additional mechanism for stopping the second lid member, which contributes to simplification of the apparatus.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a substrate treating apparatus in Embodiment 1;

FIG. 2 is an enlarged fragmentary side view showing an auto cover in a closed state;

FIG. 3 is an enlarged fragmentary plan view showing the auto cover in the closed state;

FIG. 4 is an explanatory view of operation in time of substrate loading;

FIG. 5 is an explanatory view of operation in time of substrate loading;

FIG. 6 is an explanatory view of operation in time of substrate loading;

FIG. 7 is a flow chart showing a sequence of treatment;

FIG. 8 is a graph showing changes in temperature and specific gravity in Embodiment 1;

FIG. 9 is a graph showing changes in temperature and specific gravity in a conventional apparatus; and

FIG. 10 is a side view in vertical section showing a principal portion of Embodiment 2.

### DESCRIPTION OF THE PREFERRED EMBODIMENTS

Preferred embodiments of this invention will be described in detail hereinafter with reference to the drawings.

### Embodiment 1

Embodiment 1 of the invention will be described in detail hereinafter with reference to the drawings.

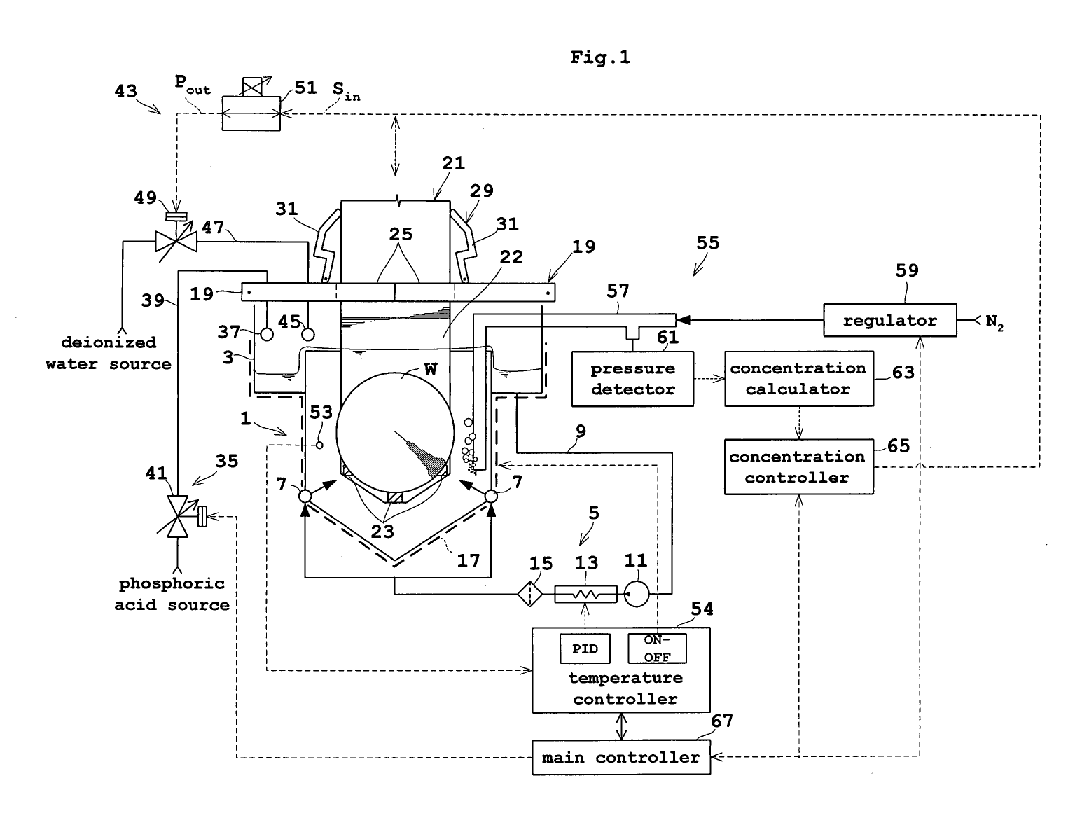

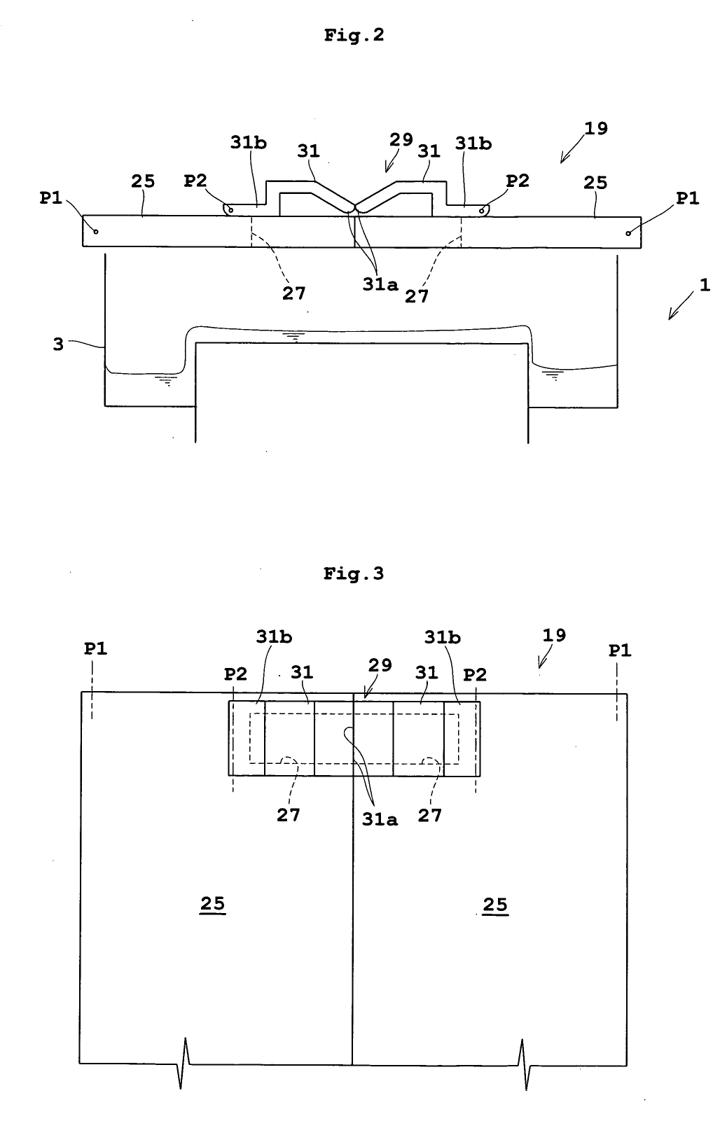

FIG. 1 is a block diagram showing an outline of a substrate treating apparatus in Embodiment 1. FIG. 2 is an enlarged fragmentary side view showing an auto cover in a closed state. FIG. 3 is an enlarged fragmentary plan view showing the auto cover in the closed state.

A treating solution used in this apparatus is a phosphoric acid solution obtained by mixing phosphoric acid acting as a chemical and deionized water acting as a diluent. The phosphoric acid solution is heated, and substrates (e.g. semiconductor wafers) are immersed in the solution for etching treatment.

This substrate treating apparatus includes a treating tank 1 for storing the phosphoric acid solution. Around the treating tank 1 is a collecting tank 3 for collecting the phosphoric acid solution overflowing the treating tank 1. The phosphoric acid solution collected in the collecting tank 3 is returned to the treating tank 1 through a circulating system 5. The circulating system 5 includes piping 9 for communicating the collecting tank 3 to injection pipes 7 disposed adjacent the bottom of the treating tank 1. The piping 9 has, arranged thereon, a circulating pump 11, a circulating system heater 13 and a filter 15. The circulating system heater 13 is used for heating the phosphoric acid solution returned to the treating tank 1. The filter 15 is provided to remove particles from the phosphoric acid solution returned to the treating tank 1. A tank heater 17 is disposed around the treating tank 1 and collecting tank 3 for heating the phosphoric acid solution in the tanks.

An auto cover 19 (first lid member) is disposed above the treating tank 1 for opening and closing an upper opening of the treating tank 1. A plurality of wafers W under treatment are held by a vertically movable lifter 21 as arranged in vertical posture and equidistantly thereon. The lifter 21 includes a back plate 22, and support elements 23 extending horizontally from lower positions of the back plate 22. The auto cover 19 includes a pair of cover plates 25 having long sides extending parallel to the plane of FIGS. 1 and 2, and pivotable to open and close in a double-door fashion about pivotal axes P1 extending perpendicular to the plane of FIGS. 1 and 2. The auto cover 19 is closed when the lifter 21 is outside the treating tank 1. The auto cover 19 is opened for allowing the lifter 21 to load the group of wafers W as held on the support elements 23 into the treating tank 1. While the group of wafers W undergoes etching treatment in the tank 1, the auto cover 19 remains closed. The auto cover 19 has an insert opening 27 formed therein in order to avoid interference between the back plate 22 of the lifter 21 and the cover plates 25 when the auto cover 19 is closed in time of treatment. The insert opening 27 is disposed in abutting sides of the cover plates 25, and is slightly larger than cross-sectional outer dimensions of the back plate 22. That is, the insert opening 27 is sized to allow a fine adjustment to be made to the position of the group of wafers W in the treating tank 1 by moving the back plate 22 of the lifter 21 along the plane of FIG. 1.

A sub cover 29 (second lid member) is provided for the insert opening 27. The sub cover 29 includes a pair of cover plates 31 (lid plates) having long sides parallel to the short sides of the cover plates 25, and short sides parallel to the long sides of the cover plates 25. The pair of cover plates 31 have a larger area than the insert opening 27 in plan view to cover the insert opening 27 completely. The cover plates 31 have open and close axes P2 at the ends thereof opposed to the pivotal axes P1. As shown in FIG. 2, the pair of cover plates 31 have a cross-sectional shape resembling letter “M” of the alphabet. The cover plates 31 may be formed of PTFE which is a fluororesin, for example. The forward end 31a, which is a contact side, of each cover plate 31 is rounded in order to reduce the coefficient of friction in time of contact with a side of the back plate 22. When the sub cover 29 is closed, lower surfaces in proximal end regions 31b of the cover plates 31 are in contact with upper surfaces of the cover plates 25. The cross-sectional shape resembling letter “M” of the sub cover 29 gives a certain mechanical strength to the sub cover 29, and at the same time secures sufficient laterally opening areas required for water evaporation in time of a heating process.

The cross-sectional shape of the sub cover 29 is not limited to the letter “M”. A different cross-sectional shape may be employed as long as water can be sufficiently evaporated.

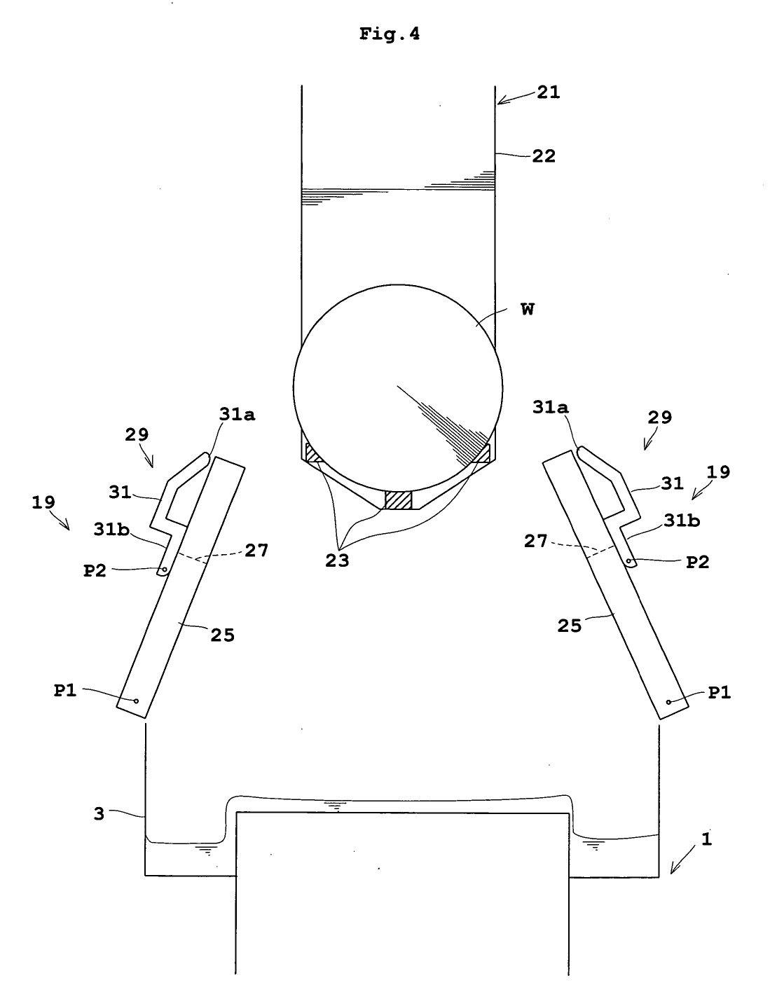

Operation of the auto cover 19 having the above construction will be described with reference to FIGS. 4 through 6. FIGS. 4 through 6 are explanatory views of operation in time of substrate loading.

As shown in FIG. 4, the auto cover 19 is opened when a group of wafers W placed in upstanding posture on the support elements 23 of the lifter 21 is on standby above the treating tank 1. The sub cover 29 maintains the same posture relative to the auto cover 19 even when the auto cover 19 is opened to an inclined posture. That is, the lower surfaces in the proximal end regions 31b of the cover plates 31 of the sub cover 29 are in close contact with the upper surfaces of the cover plates 25.

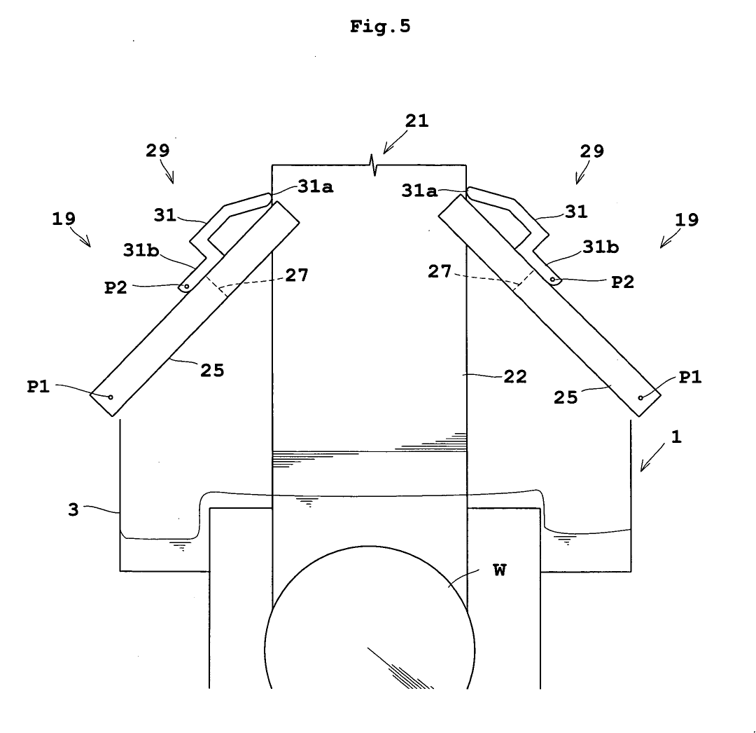

Subsequently, as shown in FIG. 5, the lifter 21 is lowered into the treating tank 1, and the group of wafers W placed on the support elements 23 is immersed into the treating solution in the treating tank 1. Then, the auto cover 19 begins to be closed. During this process, as shown in FIG. 5, the cover plates 25 never contact the back plate 22 owing to the presence of the insert opening 27. On the other hand, the distal ends 31a of the cover plates 31 of the sub cover 29 contact the sides of the back plate 22 of the lifter 21.

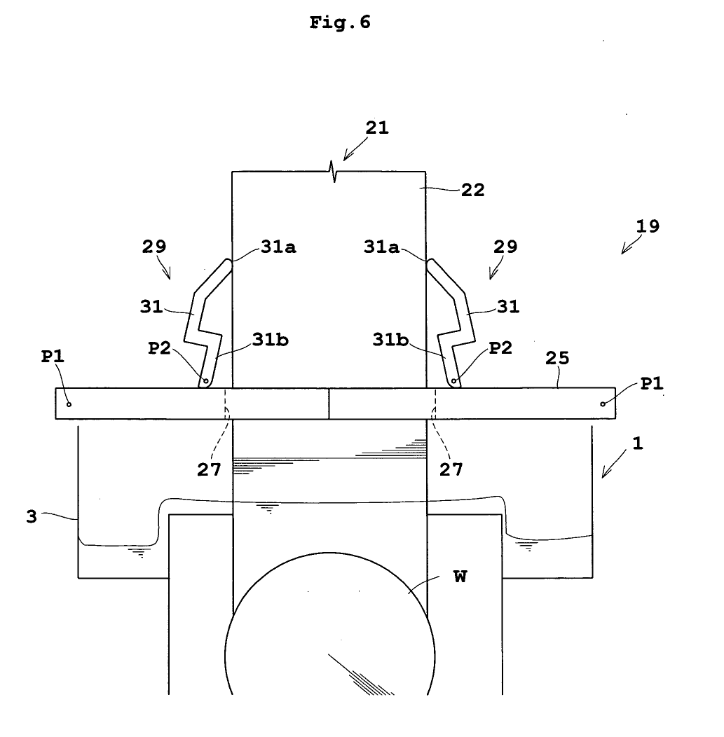

As the auto cover 19 is closed further, as shown in FIG. 6, the cover plates 31 begin to pivot about the open and close axes P2 away from the cover plates 25, thereby separating the proximal end regions 31b from the upper surfaces of the cover plates 25. When the auto cover 19 is completely closed, the sub cover 29 remains leaning on the back-plate 22. During these processes, the cover plates 31 slide along the sides of the back plate 22, but the rounded distal ends 31a have the effect of producing no particles. Thus, the wafers W are free from adverse influences of particles. The treatment of the wafers W is performed in such a state.

Since the open and close axes P2 of the sub cover 29 are provided on the upper surface of the auto cover 19, the sub cover 29 may be opened and closed on the auto cover 19, following inclined postures of the auto cover 19 being opened and closed. The sub cover 29 needs no driving device of its own, thereby simplifying the construction. Since the posture of the sub cover 29 is stabilized by the distal ends 31a contacting the back plate 22 of the lifter 21, no additional mechanism is required for stopping the sub cover 29, and this also contributes to simplification of the apparatus construction.

Reference is made again to FIG. 1.

A phosphoric acid supply device 35 is provided for supplying phosphoric acid to the collecting tank 3. The phosphoric acid supply device 35 includes a nozzle 37 disposed in an upper position of the collecting tank 3, piping 39 for connecting the nozzle 37 to a phosphoric acid source, and a flow regulating valve 41 mounted on the piping 39. A deionized water supplementing device 43 is provided for supplementing deionized water to the treating tank 1. The deionized water supplementing device 43 includes a nozzle 45 disposed adjacent an edge of the treating tank 1, piping 47 for connecting the nozzle 45 to a deionized water source, and an air control valve 49 mounted on the piping 47.

An electro-pneumatic converter 51 applies an output pressure Pₒᵤₜ to the air control valve 49 to adjust a cross-sectional passage area thereof, thereby to adjust a deionized water flow rate through the piping 47 with high precision. The electro-pneumatic converter 51 is also called an electro-pneumatic regulator, and converts compressed air of predetermined pressure applied thereto into the output pressure Pₒᵤₜ according to an input signal Sᵢₙ. As the input signal Sᵢₙ, for example, 4 to 20 [mA] are applied, and the output pressure Pₒᵤₜ is adjusted to 0 to 1.0 [MPa] in response thereto. Upon receipt of the output pressure Pₒᵤₜ, the air control valve 49 adjusts the deionized water flow rate through the piping 47 to 0 to 400 [mL/min]. With this construction, the air control valve 49 linearly adjusts the deionized water flow rate according to the output pressure Pₒᵤₜ from the electro-pneumatic converter 51. The input signal Sᵢₙ is applied to the electro-pneumatic converter 51 from a concentration controller 65 described hereinafter.

The treating tank 1 includes a temperature sensor 53 for detecting the temperature of the phosphoric acid solution stored therein. A detection signal of the temperature sensor 53 is applied to a temperature controller 54. Based on this detection signal, the temperature controller 54 carries out a PID (proportional, integral and differential) control of the circulating system heater 13, and an ON/OFF control of the tank heater 17. Specifically, the temperature controller 54 controls the circulating system heater 13 so that the temperature of the phosphoric acid solution is maintained in the range of 159.7 to 160.3° C. When the temperature of the phosphoric acid solution is at or below 160.3° C., the temperature controller 54 maintains the tank heater 17 in ON state. When the temperature of the solution exceeds 160.3° C., the temperature controller 54 turns off the tank heater 17.

Further, a concentration detecting device 55 is provided for the treating tank 1 for detecting the concentration of the phosphoric acid solution therein. Noting the fact that a correlation exists between the concentration of the phosphoric acid solution and the specific gravity thereof, the concentration detecting device 55 is arranged to detect the concentration of the phosphoric acid solution by substantially detecting the specific gravity of the solution. Since the specific gravity of the phosphoric acid solution has a correlation with a pressure at a predetermined depth in the treating tank 1, the concentration detecting device 55 has a detecting element at the predetermined depth in the treating tank 1, and detects the concentration of the phosphoric acid solution by detecting a pressure of the treating solution applied to this element. A specific construction of the concentration detecting device 55 will be described hereinafter.

The concentration detecting device 55 includes a detection pipe 57, a regulator 59, a pressure detector 61 and a concentration calculator 63. The detection pipe 57 is formed of a fluororesin resistant to the phosphoric acid solution, and has a tip end thereof acting as the detecting element located at the predetermined depth in the treating tank 1. The regulator 59 supplies nitrogen gas from a nitrogen gas source at a constant flow rate into the detection pipe 57. In a normal state, a nitrogen gas discharge pressure may be considered nearly equal to the liquid pressure at the predetermined depth from the liquid surface in the treating tank 1. The pressure detector 61 has a pressure sensor for measuring a nitrogen gas pressure in the detection pipe 57. Thus, an output signal from the pressure detector 61 may be regarded as the liquid pressure at the predetermined depth from the liquid surface in the treating tank 1. The concentration calculator 63 has, stored therein in advance, working curve data showing a correspondence between voltage and concentration according to a pressure from the pressure detector 61. The concentration calculator 63 derives a concentration of the phosphoric acid solution in the treating tank 1 from the detection signal (voltage) received from the pressure detector 61.

A specific concentration calculating method is described in detail in Japanese Unexamined Patent Publication No. 11-219931 (1999), and will not particularly be described herein. Briefly, this method is as follows.

The detection signal (voltage) from the pressure detector 61 and the liquid pressure have a fixed functional relationship therebetween. The liquid pressure may be expressed also as a sum of atmospheric pressure and a value proportional to the product of a distance (depth) from the liquid surface to the detecting element of the detection pipe 57 and the specific gravity of the phosphoric acid solution. Therefore, the liquid pressure acting on the detecting element may be expressed by a function having variables consisting in the concentration of the phosphoric acid solution and the depth of the detecting element. Thus, the concentration and depth are in a fixed relationship with the voltage outputted from the pressure detector 61. Based on this relationship, a concentration of the phosphoric acid solution may be derived from the voltage outputted from the pressure detector 61 by determining beforehand a relationship between concentration and voltage for the predetermined depth.

Concentration data of the phosphoric acid solution provided by the concentration detecting device 55 is applied to the concentration controller 65. The concentration controller 65 controls the electro-pneumatic converter 51 noted hereinbefore to adjust the air control valve 49, so that the detected concentration of the phosphoric acid solution becomes slightly higher than a boiling point concentration corresponding to a preset temperature of the phosphoric acid solution. Based on this, an adjustment is made to the replenish amount of deionized water to be supplied from the nozzle 45 to the treating tank 1. Specifically, the concentration controller 65 controls the electro-pneumatic converter 51 by PID (proportional, integral and differential) control based on the detected concentration of the phosphoric acid solution.

A main controller 67 is provided to perform an overall control of the substrate treating apparatus. Specifically, the main controller 67 gives a command of a set temperature of the phosphoric acid solution to the temperature controller 54, a command of a target concentration of the phosphoric acid solution to the concentration controller 65, a control command to the phosphoric acid flow regulating valve 41, and so on.

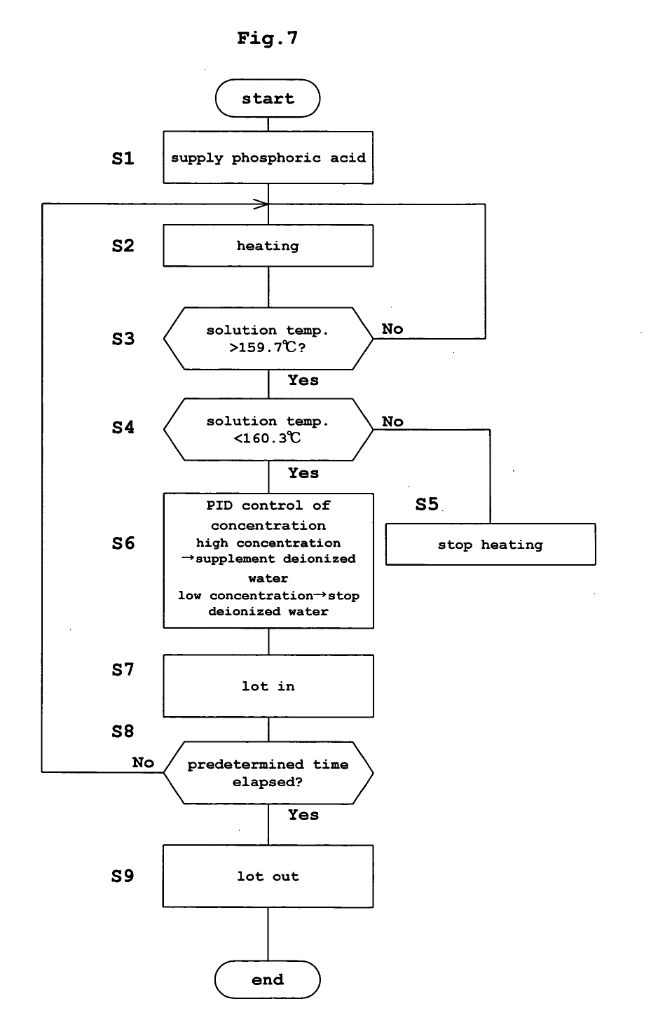

Next, operation of this substrate treating apparatus will be described with reference to the flow chart shown in FIG. 7. In the following operation up to step S6, the auto cover 19 remains closed as shown in FIGS. 1 through 3.

Steps S1 and S2

First, the phosphoric acid flow regulating valve 41 is opened to supply phosphoric acid from the nozzle 37 to the collecting tank 3 (step S1). The phosphoric acid supplied to the collecting tank 3 is heated by the circulating system heater 13 while being transmitted to the treating tank 1 through the circulating system 5 (step S2). The phosphoric acid introduced into the treating tank 1 is heated also by the tank heater 17.

Steps S3, S4 and S5

The temperature of the phosphoric acid in the treating tank 1 is detected by the temperature sensor 53, and a corresponding signal is applied to the temperature controller 54. The temperature controller 54 controls the temperature of the phosphoric acid to be within ±0.3° C. of a predetermined temperature of 160° C. Specifically, when the solution temperature is found in step S3 to be below 159.7° C., the heating by the circulating system heater 13 and tank heater 17 is continued. When the solution temperature is found in step S4 to exceed 160.3° C., the heating by the circulating system heater 13 and tank heater 17 is stopped to allow the solution temperature to lower by natural cooling (step S5). When the solution temperature is brought within the range of 159.7 to 160.3° C., the operation proceeds to step S6.

Step S6

The concentration of the solution in the treating tank 1 is detected from time to time by the concentration detecting device 55. The concentration controller 65 adjusts the input signal Sᵢₙ to the electro-pneumatic converter 51 by PID control for controlling the air control valve 49 to supplement the treating tank 1 with deionized water so that the detected concentration agrees with a target concentration set before-hand. This target concentration is set to be slightly higher than the boiling-point concentration corresponding to the set temperature of the phosphoric acid solution. When the detected concentration of the phosphoric acid solution in the treating tank 1 exceeds a target concentration range, the supplementing of deionized water is continued. When the detected concentration is less than the target concentration range, the supplementing of deionized water is stopped. When the supplementing of deionized water is stopped, the deionized water in the phosphoric acid solution evaporates by the heating of the phosphoric acid solution, whereby the concentration of the phosphoric acid solution increases automatically.

As noted above, the electro-pneumatic converter 51 can change the output pressure Pₒᵤₜ linearly according to the input signal Sᵢₙ from the concentration controller 65. Thus, by operating the air control valve 49 accordingly, the replenish amount of deionized water may be linearly adjusted according to the output pressure Pₒᵤₜ. Consequently, deionized water may be replenished with high accuracy in response to the concentration detected by the concentration detecting device 55.

In the above process, when the temperature of the phosphoric acid solution reaches 140° C. or thereabouts, the solution boils intensely to evaporate water while scattering droplets upward from the liquid surface. However, the auto cover 19 has the insert opening 27 with the sub cover 29 which is also closed. The upward scattering of phosphoric acid droplets is prevented by the sub cover 29. Since the sub cover 29 has lateral openings, the water evaporation from the phosphoric acid solution is not hampered. Consequently, the phosphoric acid solution can be stabilized in a sub-boil state quickly while preventing scattering of droplets in the boiling state.

Steps S7, S8 and S9

When the phosphoric acid solution in the treating tank 1 is brought into and stabilizes in the target concentration range, the auto cover 19 is opened and the group of wafers W held by the lifter 21 is loaded into the treating tank 1 as shown in FIGS. 4 through 6. Then, etching treatment of the wafers W in the sub-boil state is started (step S7). The temperature control and concentration control in steps S2-S6 are repeated until a predetermined treating time elapses in step S8. After the treating time, the group of wafers W is withdrawn upward from inside the tank 1 and transferred to a next treating tank not shown (step S9).

In this embodiment, as described above, when the temperature of the phosphoric acid solution exceeds the set temperature range, the temperature of the solution is lowered by stopping the heating without supplying deionized water (step S5 in FIG. 7). Further, the concentration control is performed only when the temperature of the phosphoric acid solution is in the range of 159.7 to 160.3° C. (step S6).

The above controls are performed for the following reason. If deionized water is supplied in order to lower the temperature of the phosphoric acid solution having risen to 170° C., for example, the concentration of the phosphoric acid solution will become lower. Then, the phosphoric acid solution could reach a boiling point to cause bumping before reaching a target concentration corresponding to a set temperature. In order to avoid bumping, it is necessary to supplement deionized water gradually. Then, a long time will be taken to bring the phosphoric acid solution to the set temperature.

In this embodiment, however, since the temperature of the phosphoric acid solution is controlled only by operation of the circulating system heater 13 and the tank heater 17, the concentration of the phosphoric acid solution remains unchanged even if the temperature of the phosphoric acid solution is varied. This precludes the possibility of bumping of the phosphoric acid solution. The supplementing of deionized water for adjusting the concentration of the phosphoric acid solution is performed only when the temperature of the phosphoric acid solution is in the set temperature range. Thus, this embodiment is free from bumping due to the supplementing of deionized water. Moreover, since the supplementing of deionized water is performed by adjusting the output pressure Pₒᵤₜ of the electro-pneumatic converter 51 to control the air control valve 49, a high etching rate of the treating solution may be maintained with high precision while preventing bumping of the solution.

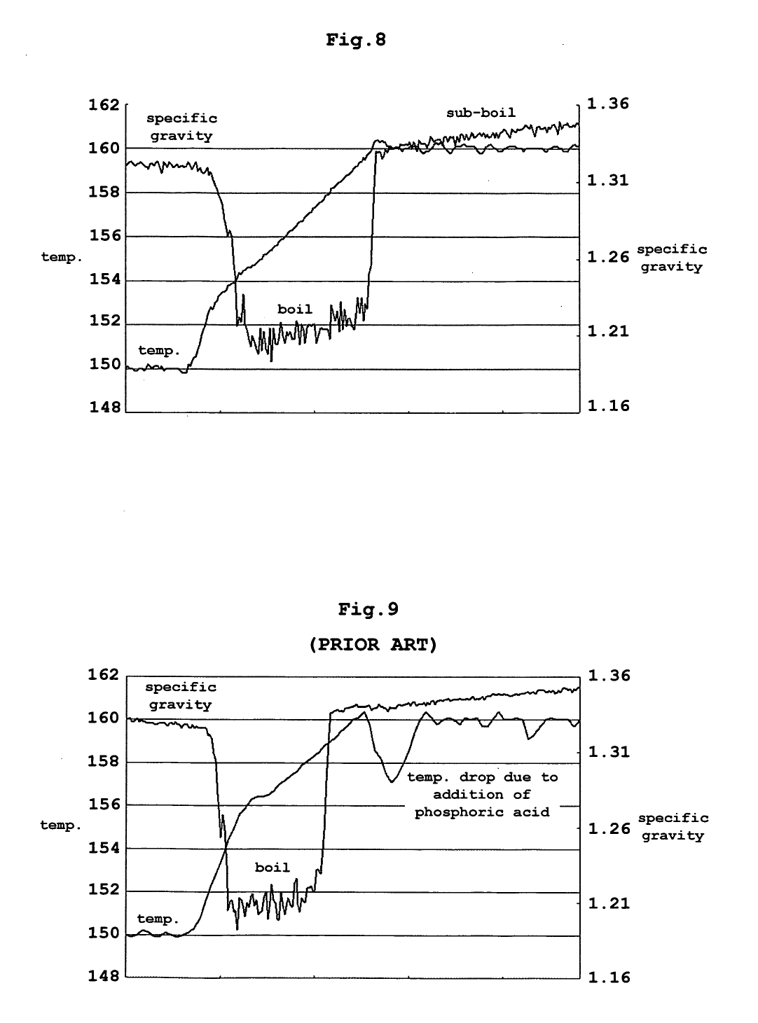

Next, this Embodiment 1 is compared with a conventional apparatus with reference to FIGS. 8 and 9. FIG. 8 is a graph showing changes in temperature and specific gravity in Embodiment 1. FIG. 9 is a graph showing changes in temperature and specific gravity in the conventional apparatus. In the conventional apparatus, while the data shown is collected, droplets of the treating solution scatter from the insert opening 27, whereby the volume of phosphoric acid decreases after bumping. The temperature lowers temporarily by supplementing of phosphoric acid. Although this is different from ordinary temperature and concentration controls, the data serves the comparison purposes.

If a cover for droplet scattering prevention is provided for completely closing the insert opening 27, the evaporation of water will be hampered. Then, the water concentration will hardly lower, and an intense boiling state will continue for a long time, thereby consuming a long time before the treating solution stabilizes in the sub-boil state. In Embodiment 1 described hereinbefore, on the other hand, it is clear that the sub-boil state is attained although the transition from boiling state to sub-boil state takes a slightly longer time than in the conventional apparatus.

### Embodiment 2

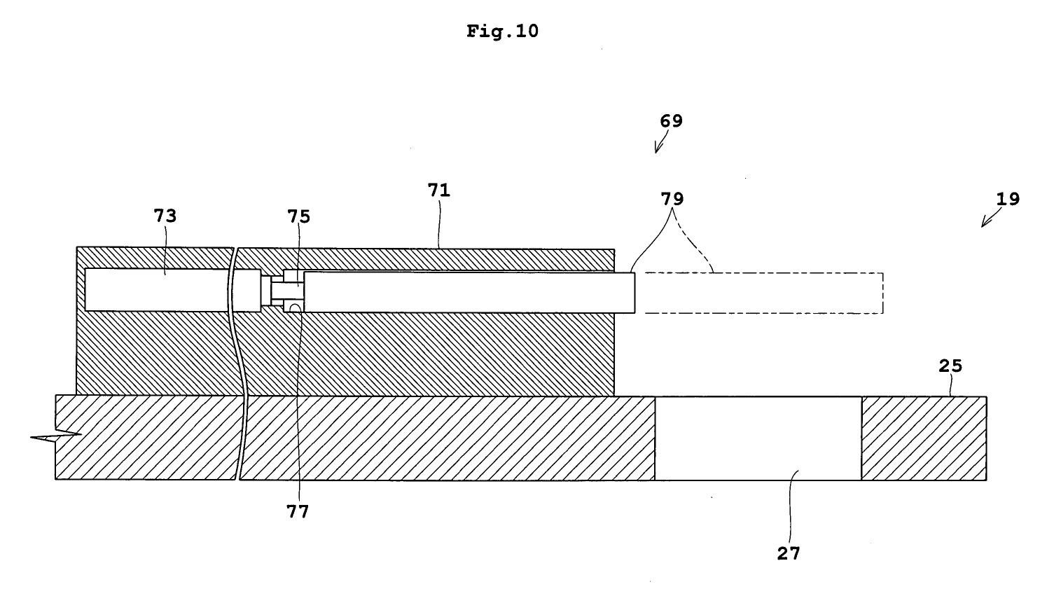

Next, Embodiment 2 of the invention will be described with reference to FIG. 10. FIG. 10 is a side view in vertical section showing a principal portion of Embodiment 2. In the following description, like reference numerals are used to identify like parts in this embodiment which are the same as in Embodiment 1, and will not be described again.

A sub cover mechanism 69 (second lid member) corresponding to the sub cover in Embodiment 1 is disposed on the upper surface of the auto cover 19 and adjacent the insert opening 27. The sub cover mechanism 69 includes a base 71 mounted on the upper surface of a cover plate 25, an actuator 73 embedded in the base 71, a guide 77 formed in the base 71 and adjacent a working piece 75 of the actuator 73, and a cover plate 79 (lid plate) disposed in the guide 77 to be movable forward and backward relative thereto. The working piece 75 of the actuator 73 is attached to an end of the cover plate 79.

During a heating operation with the auto cover 19 closed, the actuator 73 moves the cover plate 79 forward to close an area above the insert opening 27. In time of loading or unloading the wafers W, the cover plate 79 is retracted to open the area above the insert opening 27. However, even when the cover plate 79 closes the area above the insert opening 27, areas laterally of the cover plate 79 are in communication with the ambient, so that a sufficient quantity of water vapor may escape to the ambient through the insert opening 27. Such sub cover mechanism 69 is provided for each of the cover plates 25, and the two sub cover mechanisms 69 perform the same operation simultaneously.

The above construction provides the same functions and effects as Embodiment 1 described hereinbefore.

This invention is not limited to the foregoing embodiments, but may be modified as follows:

(1) The foregoing embodiments have been described by taking the phosphoric acid solution as an example of treating solution. This invention is applicable also where a different treating solution such as a sulfuric acid solution is used.

(2) This invention is applicable also to an apparatus not having a circulating pipe system as described hereinbefore for circulating a treating solution.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus for performing a predetermined treatment of substrates, comprising:
a treating tank for storing a treating solution;
a holding mechanism for holding the substrates, and loading and unloading the substrates into/from said treating tank;
a first lid member for opening and closing an upper opening of said treating tank, said first lid member having an insert opening for receiving a back plate of said holding mechanism; and
a second lid member disposed on said first lid member for opening and closing said insert opening;
wherein, when said holding mechanism is outside said treating tank and said first lid member is closed, said second lid member closes an area above said insert opening, and forms lateral openings.

2. An apparatus as defined in claim 1, wherein said second lid member includes a pair of lid plates, said pair of lid plates presenting a cross-sectional shape resembling letter M when closing the area above said insert opening.

3. An apparatus as defined in claim 1, wherein said second lid member is pivotably attached to open and close axes disposed on an upper surface of said first lid member.

4. An apparatus as defined in claim 2, wherein said second lid member is pivotably attached to open and close axes disposed on an upper surface of said first lid member.

5. An apparatus as defined in claim 1, wherein, when said holding mechanism is inside said treating tank and said first lid member is closed, a distal end of said second lid member is in contact with said back plate.

6. An apparatus as defined in claim 2, wherein, when said holding mechanism is inside said treating tank and said first lid member is closed, a distal end of said second lid member is in contact with said back plate.

7. An apparatus as defined in claim 3, wherein, when said holding mechanism is inside said treating tank and said first lid member is closed, a distal end of said second lid member is in contact with said back plate.

8. An apparatus as defined in claim 4, wherein, when said holding mechanism is inside said treating tank and said first lid member is closed, a distal end of said second lid member is in contact with said back plate.

9. An apparatus as defined in claim 1, wherein said treating solution contains phosphoric acid, and is heated to a high temperature.

10. An apparatus as defined in claim 2, wherein said treating solution contains phosphoric acid, and is heated to a high temperature.

11. An apparatus as defined in claim 3, wherein said treating solution contains phosphoric acid, and is heated to a high temperature.

12. An apparatus as defined in claim 4, wherein said treating solution contains phosphoric acid, and is heated to a high temperature.

13. An apparatus as defined in claim 5, wherein said treating solution contains phosphoric acid, and is heated to a high temperature.

14. An apparatus as defined in claim 6, wherein said treating solution contains phosphoric acid, and is heated to a high temperature.

15. An apparatus as defined in claim 7, wherein said treating solution contains phosphoric acid, and is heated to a high temperature.

16. A substrate treating apparatus for performing a predetermined treatment of substrates, comprising:
a treating tank for storing a treating solution;
a holding mechanism for holding the substrates, and loading and unloading the substrates into/from said treating tank;
a first lid member for opening and closing an upper opening of said treating tank, said first lid member having an insert opening for receiving a back plate of said holding mechanism; and
a second lid member disposed on said first lid member for opening and closing said insert opening;
wherein, when said holding mechanism is inside said treating tank and said first lid member is closed, a distal end of said second lid member is in contact with said back plate.

17. An apparatus as defined in claim 16, wherein said second lid member is pivotably attached to open and close axes disposed on an upper surface of said first lid member.

18. An apparatus as defined in claim 16, wherein, when said holding mechanism is outside said treating tank and said first lid member is closed, said second lid member closes an area above said insert opening, and forms lateral openings.

19. An apparatus as defined in claim 17, wherein, when said holding mechanism is outside said treating tank and said first lid member is closed, said second lid member closes an area above said insert opening, and forms lateral openings.

20. An apparatus as defined in claim 16, wherein said treating solution contains phosphoric acid, and is heated to a high temperature.
